(19) United States
(12) Patent Application Publication
(10) Pub. No.: US 2025/0184423 A1
(43) Pub. Date: Jun. 5, 2025

(54) Digital Waterproof Notetaking Device

(71) Applicant: Travis Paul Schnelle, Springfield, MO (US)

(72) Inventor: Travis Paul Schnelle, Springfield, MO (US)

(21) Appl. No.: 18/528,984

(22) Filed: Dec. 5, 2023

(51) Int. Cl. H04M 1/72433; G06F 3/0354; G06V 40/13; H04M 1/04; H04M 1/18; H04M 1/72409

(52) U.S. Cl. CPC H04M 1/72433; G06F 3/03545; G06V 40/13; H04M 1/04; H04M 1/18; H04M 1/72409; H04M 2250/22

(57) ABSTRACT

A waterproof digital device that allows for notes to be taken either by writing or verbally given while in a wet environment. In one embodiment the Digital Waterproof Notetaking Device includes network capabilities which will allow the notes to sync with another device on the same network or through an application or cloud based service designed for that purpose. A stylus accompanies the device which is also waterproof. The screen on the device is touch sensitive allowing the user to take notes with the stylus or finger. The device also has audio capabilities to allow for notes to be taken verbally when writing is not accessible.

### FIELD OF THE INVENTION

The present invention generally relates to the Digital Waterproof Notetaking device and more specifically allows a user to take notes in a variety of wet environments.

### BACKGROUND OF THE INVENTION

Ideas and important thoughts do not always happen while one is sitting at a desk or table with notepaper and writing instruments readily available. Often times, ideas and thoughts occur while driving or while working on another project, or in the middle of the night. Sometimes new ideas come up while actively working on site. In the event the site is in a wet environment, the use of paper or a personal cell phone is not ideal. Those who work in wet environments, such as plumbers or divers, may need a list of supplies or may need to record what they see below the surface of the water. Wet paper is useless, and the note or idea is lost. Cell phones can be badly damaged when exposed to wet conditions. Inventions do exist that allow for a paper notetaking device and the note is taken on a screen that uses pressure to transcribe the note on paper. The disadvantage is that paper still needs to be removed from the device, thereby exposing the paper to the wet conditions. That device can also not be used below the surface of the water, as the water would penetrate the device and soak the roll of paper installed, making it unusable. Currently there is not a device that be submersed in water and be used for taking notes or drawings, thereby creating a need for this type of invention.

Current relevant prior art shows an invention that encloses a roll of paper that can be used by applying pressure to a plastic screen. This can be found in the patent publication US 2009/0097903 A1. This pressure then allows the note to be transcribed onto the paper. The paper is then dispensed from the device and cut off from the remainder of the roll. The problem with this previous invention is that it cannot be submersed in water at any level as water would enter the inner chambers and soak the roll of paper, thereby negatively affecting the function of the device itself. The discovery of a device that can be submersed or used in a wet environment above the surface of the water, such as a shower, or outdoors in the rain makes the present invention novel.

The previous invention attempted to solve the problem by keeping a roll of paper enclosed in a plastic, or other material, casing and the paper is only exposed when it is rolled out of the device as the notes are taken. The disadvantage is that the paper still has to be exposed to wet conditions as the paper is rolled out of the device.

Therefore, there is a growing demand for a device that can be used in wet environments and be fully submersible under water and still function without fail. The present invention proposed will allow a fully water tight and waterproof device to meet the demands for taking notes, ideas and drawings without the possibility of losing those notes to wet conditions.

### SUMMARY OF THE INVENTION

Due to the disadvantages known in the prior art, the present invention provides a Digital Waterproof Notetaking device that allows a user to take notes in all kinds of wet conditions, even to the most extreme as submersed under water. This allows a user to keep their thoughts, lists, ideas in a secure location and can be fully retrieved later and shared with other devices on the same network or by using an application designed for sharing the ideas.

In one embodiment, the present invention can be used in a wet environment through the use of a digital notetaking device, using current technology found in cell phones or touch screen laptop devices. The overall notetaking device is sealed to created a water tight and waterproof device. The notes are written either with the accompanying stylus or the user's finger. The device comes with a tethered strap allowing the user to slide their hand between the strap and the device to maintain firm contact and control of the device to prevent accidental dropping. The device comes equipped with wireless charging capabilities using modern technology of an internal copper transmitter coil. When placed on a charging pad the transmitter coil generates an electromagnetic field that the receiver converts to electricity for battery power. As there is no port for a charging cable, this provides the advantage of using the devices in severely wet environments or when fully submersed under water.

In another embodiment, the present invention can be used in a wet environment that may not be submersed under water. This embodiment allows the device to be temporarily adhered to a flat surface either vertical or horizontal, by means of suction cups. When the user is finished, the device can be easily removed from the surface. This feature allows for notetaking while in the shower, or on the jobsite where it may be raining, or working on plumbing in which the possibility of water being present around the device.

In another embodiment, the present invention allows a user to take notes verbally rather than writing. This presents the advantage of the full use of both hands in a work environment or in other situations where both hands are needed for another task.

Although specific features, structures, embodiments, methods, objectives, benefits, advantages, functionality, and applications may have been disclosed, it will be understood by those having skill in the art that changes, including but not limited to, variations, modifications, combinations, alterations, omissions, and various other applications, will occur to those of ordinary skill in the art and such changes will be made without departing from the spirit and the scope of the invention as claimed. It should also be understood by anyone who reads this document that the terminology and phraseology used herein are for the purpose of description and should not be considered limiting.

### BRIEF DESCRIPTION OF THE DRAWINGS

The object, features and advantages of the present invention will become more apparent by describing the preferred embodiments with reference to the accompanying figures, in which:

FIG. 1 illustrates a front orthogonal view of the Digital Waterproof Notetaking device, stylus, and built in microphone in accordance with an embodiment of the present invention.

FIG. 2 illustrates a front side perspective view of the Digital Waterproof Notetaking device, stylus, and built in microphone in accordance with an embodiment of the present invention.

FIG. 3 illustrates a right side orthogonal view of the Digital Waterproof Notetaking device and strap in accordance with an embodiment of the present invention.

FIG. 4 illustrates a right side orthogonal view of the Digital Waterproof Notetaking device, strap, and a plurality of detachable connection devices in accordance with an embodiment of the present invention.

FIG. 5 illustrates a rear orthogonal view of the Digital Waterproof Notetaking device and strap and a plurality of openings for attachment of a plurality of connection devices in accordance with an embodiment of the present invention.

FIG. 6 illustrates a rear orthogonal view of the Digital Waterproof Notetaking device and strap and a plurality of of connection devices in accordance with an embodiment of the present invention.

FIG. 7 illustrates a left side perspective view of a connection device in accordance with an embodiment of the present invention.

Corresponding reference characters indicate corresponding parts throughout the drawings. The exemplification set of characters herein is not to be construed as limiting the scope of the invention in any manner.

### DETAILED DESCRIPTION OF THE INVENTION

Embodiments of the present invention will now be described in detail with reference to the accompanying drawings, in which like reference numbers designate identical or corresponding elements in each of the different views. It is to be understood that changes can be made to these embodiments without departing from the spirit or the scope of the invention. Additionally, any details set forth in this specification are not intended to be limiting and instead simply set forth some of the many possible embodiments for the invention as claimed.

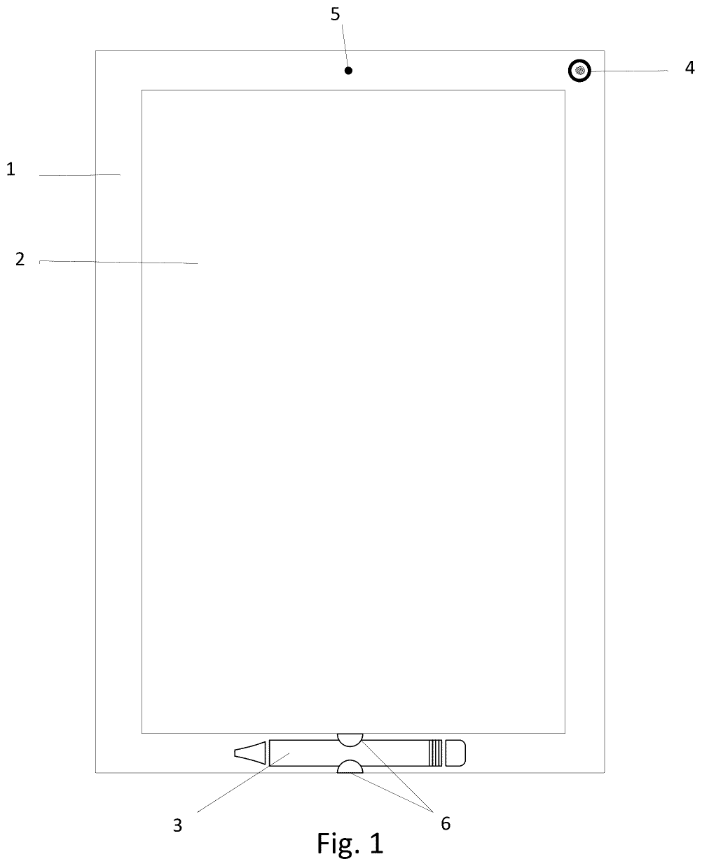

In one aspect, FIG. 1 shows an embodiment of the entire Digital Waterproof Notetaking device (1), along with a pressure sensitive or capacitive stylus (3) for transcribing on the touch panel display (2). Also shown is the finger print power button (4) for powering the device off and on and an input device (5) to allow for verbal notetaking on the device. The touch panel display (2) is an assembly of both input and output and layered on the top of an electronic visual display of the device as is consistent in mobile phones or other touch screen devices. The stylus (3) is used to register input on the touch panel display (2) however the same desired effect can be achieved by the subject using their finger. The stylus (3) is held in place, when not in use, by a plurality of clips (6) attached to the Digital Waterproof Notetaking device (1) and is non limiting in its design being made of plastic or firm rubber. The finger print power button (4) is the same material and concept to be found on other computerized devices.

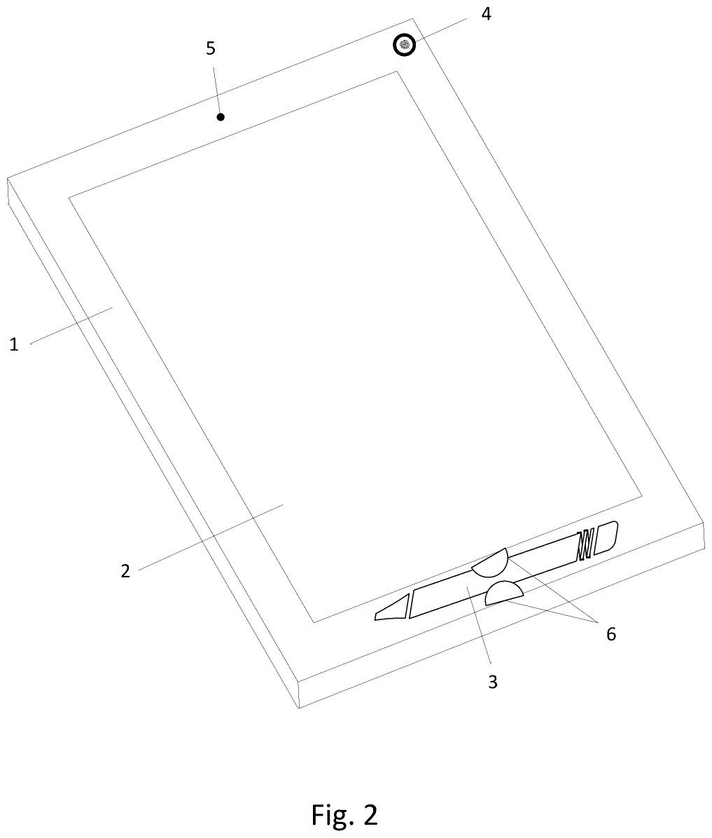

Referring to FIG. 2 the Digital Waterproof Notetaking device (1) is shown in front side perspective view and is non limiting in overall size and function and is approximately six inches (15.24 cm) in height, five inches (12.7 cm) in width and one-half inch (1.27 cm) in thickness. The touch panel display (2) is non limiting in size and is approximately five inches (12.7 cm) in height and four inches (10.16 cm) in width. The stylus (3) is non limiting in size and is approximately five and one-half inches (13.97) in length and has a circumference in direct proportion to its length.

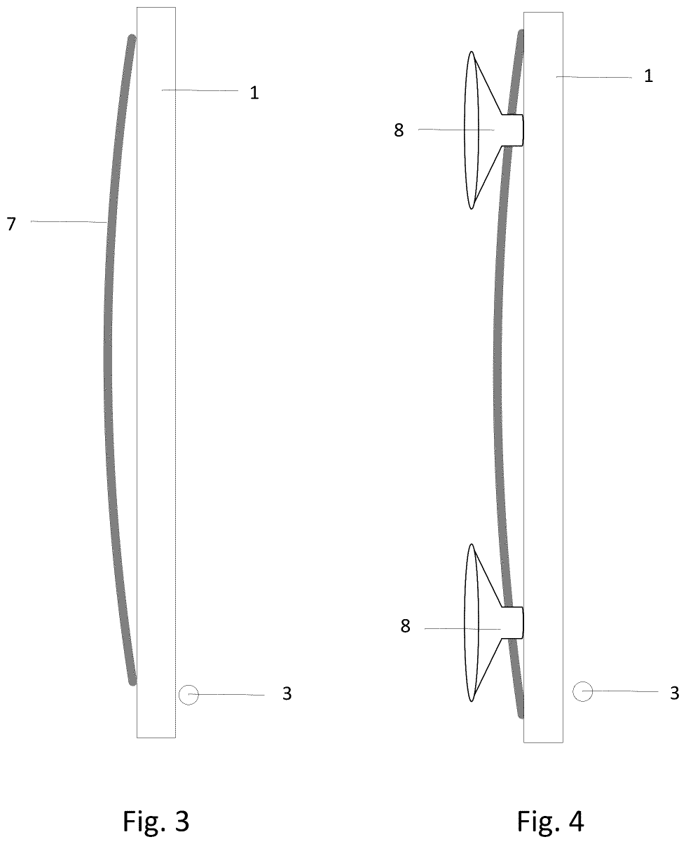

Referring to FIG. 3, the Digital Waterproof Notetaking device (1) is shown in right side orthogonal view and provides and embodiment of the strap (7) that is tethered to the rear of the device (1). The function of the strap (7) is to allow the user to slip one hand between the strap (7) and the device (1) so that the device (1) can be used while moving about a site and potentially preventing accidental dropping of the device and allowing the user's other hand to take notes. The strap is non limiting in size and is approximately five inches (12.7 cm) in length, one inch (2.54 cm) in width, and one-eighth inch (0.3175 cm) in thickness. The strap (7) is made of a water safe material, such as sailcloth, and is non limiting in design.

Referring to FIG. 4, the Digital Waterproof Notetaking device is shown in right side orthogonal view and provides and additional embodiment of a plurality of connection devices (8) that allow the device to be adhered to a flat surface so that the device can be used while the user is in a static location and to prevent accidental dropping of the device and is non limiting in design

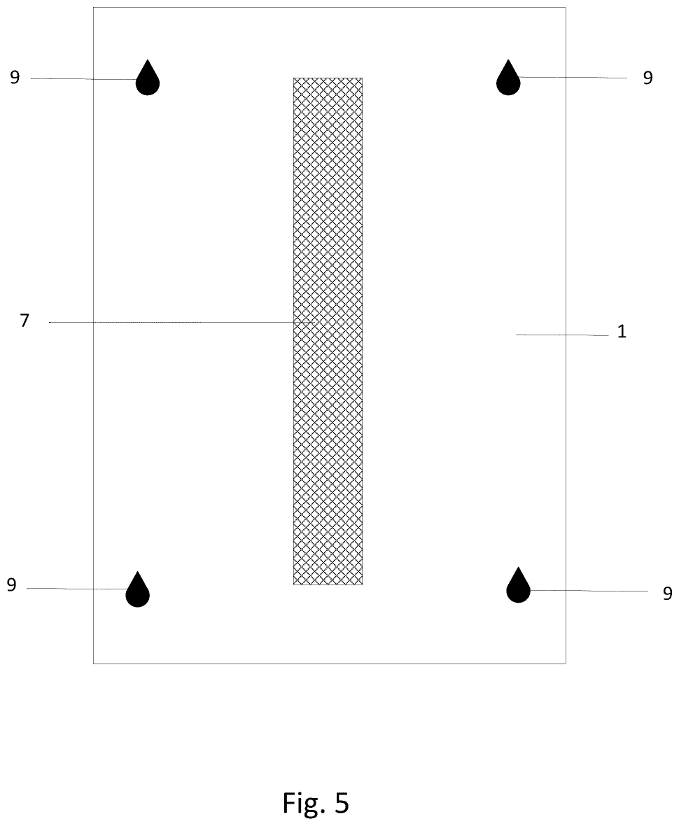

Referring to FIG. 5, the Digital Waterproof Notetaking device (1) is shown in rear orthogonal view and provides a view of the strap (7) that is tethered to the rear of the device (1). This view also demonstrates the ability of the connection devices (8) to be inserted into the device with a plurality of insertion points (9) which are large enough in diameter at the base of the insertion point (9) to receive the proximal end of the connection device and small enough at the tip of the insertion point (9) to make a snug connection between the connection device (8) and the device (1). The size of the insertion point (9) is non limiting and in proportion to the connection device (8).

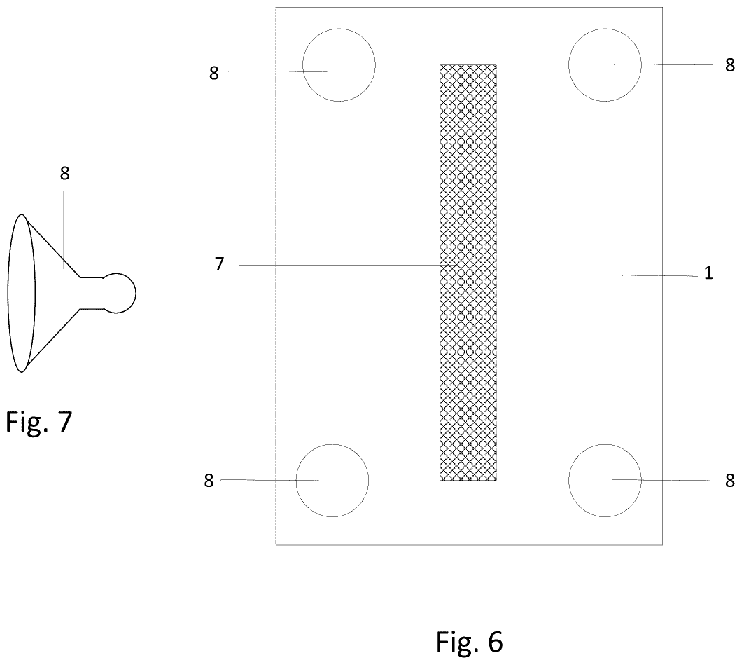

Referring to FIG. 6, the Digital Waterproof Notetaking device (1) is shown in rear orthogonal view and provides a view of the strap (7) and a plurality of connection devices (8) in place using the insertion points (9).

Referring to FIG. 7, the connection device (8) is shown in left side orthogonal view. The cup portion is non limiting in size and can be as large as one inch (2.54 cm) in height and one inch (2.54 cm) in width, with an overall circumference of 3.142 inches (7.98068 cm).

It will be readily apparent to anyone who reads this document that at least one embodiment of the Digital Waterproof Notetaking device provides an advantage over existing similar devices that use paper. The digital nature allows for notes, drawings, or ideas that are written on the device to be communicated to other devices on the same network, existing wireless technologies, or through an application. Although only certain embodiments were disclosed in this document, many other variations are possible. For example, an application can be created that transmits data to the cloud or would be installed on a user's cellular phone, or other digital device, which would allow for the transmission of notes, drawings, or ideas to a variety of devices or services.

Although specific features, structures, embodiments, methods, objectives, benefits, advantages, functionalities, and applications may have been disclosed, it will be understood by those having skill in the art that changes, including but not limited to, variations, modifications, combinations, alterations, omissions, and various other applications, will occur to those of ordinary skill in the art and such changes will be made without departing from the spirit and the scope of the invention as claimed. Further, it is to be understood by anyone who reads this document that the terminology and phraseology used herein are for the purpose of description and should not be considered limiting. Even further, the drawings illustrating embodiments of the present invention are used for schematic representation. The actual systems, devices, and methods of the embodiments of the present invention may depart from the foregoing schematics without departing from the spirit or the scope of the present invention.

What is claimed is:

1. A Digital Waterproof Notetaking device, comprising:
a waterproof casing, the casing configured with a watertight seal;
a touch panel display, for taking notes using current technology found on touch screen devices;
an internal microphone;
a fingerprint power button for powering the device on and off;
an internal electronics charging system;
a stylus configured with a watertight seal
a clip assembly for holding the stylus when not in use;
a strap on the rear of the device;
a plurality of insertion points on the rear of the device; and
a plurality of connection devices to be attached on the rear of the device.

2. The waterproof casing of claim 1, consisting of non limiting material and can be made of an alloy such as aluminum-magnesium or titanium, or any other material found compatible, wherein the casing is configured to be both waterproof and sealed in such a manner to be watertight preventing any moisture from entering the inner workings of the device.

3. The touch panel display of claim 1, consisting of non limiting material and can be made of glass and covered with a thin layer of an electronically conducting material, or suitable substrate, wherein is found current technology used in devices for touch screen response capabilities and is also waterproof and watertight.

4. The internal microphone of claim 1, wherein is used non limiting technology found in current devices which respond to a user's voice, that will allow the user to speak into the microphone to communicate notes and triggers activation and system or user functions and wherein the microphone is sealed to ensure a watertight and waterproof design.

5. The fingerprint power button of claim 1, wherein is used non limiting modern technology for powering on and off the device similar to that used with devices that allow for fingerprint recognition. The absence of a standard power button allows for one less potential entry point of water into the device. And wherein said fingerprint power button is connected to the internal electronics powering system.

6. The internal electronics powering system of claim 1 wherein is used non limiting modern technology of that of an internal receiver induction coil made of copper which allows for the charging of the internal electronics and wherein is connected to the electronics to power on and off the device. Any current existing wireless charging system may be utilized as well.

7. The stylus of claim 1 wherein is used non limiting material and which the body of the stylus could be made of plastic, metal, or any other substance found to be favorable and wherein the tip is made of non limiting material but could be made of conductive rubber to allow the user to write on the touch panel display.

8. The clip assembly of claim 1 wherein is designed to receive the stylus to create a secure coupling to prevent the stylus from falling out on its own and wherein is designed to allow the stylus to be detachably coupled from the clip assembly.

9. The strap of claim 1 wherein is made of non limiting material but could be made of sail-cloth fabric that is waterproof and non deteriorating and wherein is tethered to the rear of the device to allow the user to slip their hand between said fabric strap and rear of device for management of device while in use creating a close secure means of holding onto said device to prevent accidental dropping.

10. The plurality of insertion points of claim 1, wherein are designed receptables for receiving a connection device such as a suction cup, the lower portion of the receptable being large enough to receive the proximal end of the suction cup and the upper portion being smaller in proportion to the lower portion to create a secure fit around proximal end of the suction cup. Additional connection devices could utilize the same or similar system for attachment.

11. The insertion points of claim 10, wherein is designed a negative space large enough to receive the proximal end of the suction cup while still maintaining the integrity of the watertight casing of the device.

12. The plurality of connection devices of claim 1, wherein are made of non limiting flexible material which can include pvc plastic or neoprene.

13. The connection devices of claim 12, wherein the proximal end is rounded and is small enough to fit into an insertion point on the rear of the device to be held in place and wherein the distal end is non limiting in size but can be approximately one inch in diameter.

14. A method for writing by a user while in a wet environment, the method comprising:
a user removing the stylus from the clip assembly;
a user manipulating the stylus to makes notes or drawings on the touch panel display; and
a user saving the notes or drawings in the memory of the device.

15. A method of retrieving the saved notes or drawings, the method comprising:
a user accessing the notes or drawings from the memory of the device;
a user transferring the saved notes or drawings to another device by means of an application or service.
